(19) United States
(12) Patent Application Publication
(10) Pub. No.: US 2011/0022802 A1
(43) Pub. Date: Jan. 27, 2011

(54) Controlling data accesses to hierarchical data stores to retain access order

(75) Inventors: Frederic Jean Denis Arsanto, Antibes (FR); Pierre Michel Boyer, Vence (FR)

Correspondence Address: NIXON & VANDERHYE P.C., 901 N. Glebe Road, 11th Floor, Arlington, VA, 22203-1808, US

(73) Assignee: ARM Limited, Cambridge (GB)

(21) Appl. No.: 12/458,913

(22) Filed: Jul. 27, 2009

(51) Int. Cl. G06F 12/00; G06F 12/08

(52) U.S. Cl. 711/122; 711/154; 711/E12.001; 711/E12.024

(57) ABSTRACT

Data storage circuitry for controlling access to data stored in a memory is disclosed. The data storage circuitry comprises: a data store for storing a subset of the data stored in the memory; access circuitry for receiving access requests and for outputting the requested data, at least some of the received access requests being ordered access requests requiring the accessed data to be output in a same order as the access requests are received in; control circuitry for controlling access to the data; and retrieval circuitry for retrieving the data from the memory; wherein the control circuitry is responsive to an access request received from the access circuitry to access the data store and in response to detecting a miss in the data store when the requested data is not stored in the data store to transmit the access request to the retrieval circuitry; the retrieval circuitry being configured to retrieve requested data from the memory in response to the access request and to store the data in the data store and being responsive to no asserted output inhibit signal associated with the data access request to transmit the retrieved data to the access circuitry for output and being responsive to an asserted output inhibit signal associated with the data access request not to transmit the retrieved data to the access circuitry; the data storage circuitry further comprising detection circuitry for detecting an earlier ordered access request that misses in the data store and a later ordered access request that hits while the earlier ordered access request is pending, the data storage circuitry being configured to halt the later ordered access request and in response to receipt of a subsequent ordered access request while the earlier ordered request is still pending to assert an output inhibit signal associated with the subsequent ordered access request and in response to detection of completion of the earlier ordered access request to deassert the output inhibit signal.

### BACKGROUND OF THE INVENTION

1. Field of the Invention

The field of the invention relates to accessing data in data processing systems and in particular to controlling data accesses to hierarchical data stores to retain access order.

2. Description of the Prior Art

Storing data for processing by a processor, is often done using hierarchical data stores, such that data that is currently being used or is likely to be used is stored in a first level store, such as a level 1 cache which may be on the core itself, and as such is quick and easy to access. A second level store such as a level 2 cache may be provided to store further data that is also likely to be required. This store can generally store more data than the level 1 cache but takes longer to access. A higher third level data store such as a memory may also be provided and this stores all of the data but takes a long time to access. Various updating regimes are known for both the level 1 and level 2 caches to try to keep the subset of data that they store relevant for processes currently being performed by the processor. This is important for the performance of the processor.

Level 2 caches of the prior art are known that comprise access circuitry consisting of a slave port that receives read requests. This port comprises several read slots that store information relating to pending reads and are used to manage these pending reads. The port also has line read buffers or LRBs for storing data retrieved from the level 2 cache prior to outputting it.

In some systems read requests have an identifier associated with them, and requests with the same identifier need to output their data in the same order that they were received in. This is not a problem if consecutive reads hit or miss in the L2 cache, as in these cases the order is automatically preserved. However, if the first read misses and the second hits, then the second read will return its data for output many cycles before the first read returns its data. In L2 caches with a limited numbers of LRBs, and more slots for storing outstanding reads than there are LRBs, this is a problem as filling an LRB with data from the second read and retaining it ready for output until the first read has completed will result in the LRB not being available for any other pending read. In order to avoid this occurring, data from the second read is not stored in the LRB if there is a preceding read that is still pending, rather the read is halted and the read access will be requested again after the first read has completed.

This is not very detrimental for performance as the second read is a hit and thus, repeating it does not increase the latency of the system by very much. A problem for performance occurs if consecutive reads, are a miss followed by a hit followed by a miss. The policy of halting the second read and issuing it again when the first read has completed, means that the third read cannot be requested until after the second read has been requested again to maintain order. Thus, the third read request is only issued after the first read that missed has returned its data. This introduces a substantial delay into the system as when the third read is issued it too will miss. Thus, in this case the three reads will have the latency for accessing the memory occurring twice.

It would be advantageous to alleviate the problems of latency where several misses that are interspersed with hits occur, without unduly increasing the area of the device.

### SUMMARY OF THE INVENTION

A first aspect of the present invention provides data storage circuitry for controlling access to data stored in a memory, said data storage circuitry comprising: a data store for storing a subset of said data stored in said memory; access circuitry for receiving access requests and for outputting said requested data, at least some of said received access requests being ordered access requests requiring said accessed data to be output in a same order as said access requests are received in; control circuitry for controlling access to said data; and retrieval circuitry for retrieving said data from said memory; wherein said control circuitry is responsive to an access request received from said access circuitry to access said data store and in response to detecting a miss in said data store when said requested data is not stored in said data store to transmit said access request to said retrieval circuitry; said retrieval circuitry being configured to retrieve requested data from said memory in response to said access request and to store said data in said data store and being responsive to no asserted output inhibit signal associated with said data access request to transmit said retrieved data to said access circuitry for output and being responsive to an asserted output inhibit signal associated with said data access request not to transmit said retrieved data to said access circuitry; said data storage circuitry further comprising detection circuitry for detecting an earlier ordered access request that misses in said data store and a later ordered access request that hits while said earlier ordered access request is pending, said data storage circuitry being configured to halt said later ordered access request and in response to receipt of a subsequent ordered access request while said earlier ordered access request is still pending to assert an output inhibit signal associated with said subsequent ordered access request and in response to detection of completion of said earlier ordered access request to deassert said output inhibit signal.

The present invention recognises that although it is important that data is output in the order that ordered accesses are received in, a data access that is a miss can be started even if an earlier access request has been halted and the data thereby retrieved from the memory, which is the process with the large latency, provided that there is some control means to prevent the accessed data from being output if there is a possibility that it might be output before a previous access request. The present invention recognises that this may occur where a hit occurs in between two misses in consecutive access instructions. It also recognises that such a circumstance is already detected in conventional data stores as it is necessary to detect access requests that miss and are followed by access requests that hit, in order to halt the access requests that hit. Thus, as this detection circuitry is already required it can be reused so that when a hit following a miss is detected an output inhibit signal associated with a subsequent access can be set. Once this output inhibit signal has been asserted then there is no need to halt the subsequent access and it can proceed. If it misses it can update the data store with the data retrieved from the memory and yet it will not output the data and break the required order.

Access of the data from the data store is a quick process and thus, this read can be performed later when the second read has output its data and only the latency associated with an access to the data store rather than the latency of access to the memory will be seen by the device.

In this simple way, the problem of two latencies relating to accessing a memory twice arising in just three data accesses is avoided without adding significant extra area to the device.

In some embodiments, said access circuitry comprises: a plurality of storage slots each of said plurality of storage slots for storing information associated with one of said received plurality of access requests during processing of said access request; at least one buffer for storing a data value retrieved from said data store prior to outputting said data value; wherein said access circuitry comprises a greater number of storage slots than it comprises buffers; and said data storage circuitry is configured to halt said later ordered access request before said later ordered access request stores a data value in said at least one buffer, and in response to detecting completion of said earlier ordered access request to issue said later ordered access request to said control circuitry again.

Although the access circuitry can be arranged in a number of ways, in some embodiments it comprises a plurality of storage slots for storing information associated with received reads. Storage slots are data storage elements for storing information relating to a pending data access request. Storing this information allows the pending reads to be managed and processed, and allows several reads to be pending at the same time. In addition to this, there are buffers that are filled with the data values retrieved from the data store prior to being output. These buffers take up a lot of area and thus, their number is limited and in embodiments of the invention there are fewer buffers than there are slots. If this is the case, it is important that these buffers are not filled with data to be output that is pending for a long period of time as this could significantly reduce the performance of the device. For this reason, an ordered access request that is a hit and follows a miss is halted before it fills the buffer with its data value, and only on completion of the earlier ordered access it or a representation of it is issued again.

In some embodiments, said data storage circuitry is connected to a processor, said processor sending said access requests via a data bus, wherein said buffers are a same size as a data value stored in said data store and said data bus has a smaller width than said data value size.

It is convenient if the buffers are the same size as the data value stored in the data store, for example if the data store is a cache they may be the same size as a line of the cache as this enables the data value to be retrieved from the data store and stored in this buffer prior to it being output. It may be that the output buses are smaller in width than the data value and thus, storing the data in the buffer prior to outputting it enables it to be output over several cycles along the bus.

In some embodiments, said access requests comprise identification data identifying a source of said access requests, access requests having the same identification data being said ordered access requests, said data storage circuitry being configured to output data from said ordered access requests in a same order that said ordered access requests are received in.

The ordered access requests, i.e. those that must have their data output in a same order as the requests are received in, may be identified as such by the identification data that is received along with the access request. This identification data generally identifies the source of the access request and thus, the access requests issued by the same source need to retain their order. A source may be a processor or device issuing an access request or it may be an application or a thread of a processor. Having data storage circuitry that is configured to output data from access requests with the same identification in the same order that they are received in is a convenient way of controlling the circuit to operate as desired.

In some embodiments, said data storage circuitry comprises a data communication path between said access circuitry and said retrieval circuitry for transmitting information regarding an access request to said retrieval circuitry, said information including said output inhibit signal.

Information regarding the access requests such as the identification data and other data that may be received along with the access request can be transmitted to the retrieval circuitry direct from the access circuitry and can be used by the retrieval circuitry to control the access. This information can include the output inhibit signal. It is important that the retrieval circuitry receives the output inhibit signal as it then knows not to output the data to the access circuitry but only to send it to the data store.

In some embodiments, said information stored by said plurality of storage slots includes identification data identifying a source of said access requests, information regarding whether said access request hits or misses in said data store and an order field, said storage slots having a same identification data having a value in said order field indicative of an order in which said slots received said requests, said access circuitry transmitting said access requests to said control circuitry in dependence upon said order field, said access circuitry being responsive to detection of completion of one of said access requests to update said order fields.

The storage slots store information that controls the accesses. This information includes information that is sent with the access request such as identification data, which identifies the source and enables one to know which requests should be ordered with respect to each other. It can also have an order field, which identifies the order that access requests with the same identification data are received and therefore need to be processed in. It can also include information regarding whether the access request hits or misses in the data store. This is important in controlling the data access, as if the data misses then it will take longer to perform than a data hit and the detection circuitry needs to be able to detect which accesses have hit and missed so that it can assert or deassert the output inhibit signal, and can also halt processing of certain access requests.

In some embodiments, said retrieval circuitry comprises a line fill buffer for storing a data value retrieved from said memory prior to storing said data value in said data store.

The retrieval circuitry may have a line fill buffer, or several line fill buffers, that it uses for storing the data value retrieved from the memory prior to storing it in the data store and possibly outputting it.

In some embodiments, said access circuitry is configured to receive prefetch access requests, said prefetch access requests being speculative access requests that request a data value that it is predicted will be required by a subsequent access request, said data storage circuitry being responsive to receipt of one of said prefetch access requests to assert said output inhibit signal associated with said one prefetch access request.

It is convenient where speculative accesses are performed to be able to prefetch data that it is predicted will be required. In this way, the data store can be filled with data values that it is likely will be required and this can reduce the number of times during real time processing that the memory needs to be accessed. Thus, in many data stores circuitry is present that can recognise prefetch instructions and not output the data from them but simply store it in the data store. Such circuitry can be reused to generate the output inhibit signal in embodiments of the present invention thereby enabling a data access request that misses where previous access requests have not completed to access the memory and retrieve the data value without outputting it. In this way, the problem of high latencies in accesses that miss, hit and then miss of the prior art can be addressed using existing circuitry, latency can thereby be reduced without substantially increasing the area of the device.

In some embodiments, said access circuitry is responsive to three consecutive ordered access requests, a first of said three access request being to data not stored in said data store, a second being to data stored in said data store and a third being to data not stored in said data store to transmit said access requests in an order received to said control circuitry; said control circuitry being responsive to said first access request to access said data store and in response to a miss wherein a requested first data value is not stored in said data store to send a request to said retrieval circuitry, said retrieval circuitry being responsive to said request to retrieve said first data value from said memory and to update said data store with said first data value and to complete said first access request by transmitting said retrieved first data value to said access circuitry for output; and said control circuitry being responsive to said second access request to access said data store and in response to a hit wherein a second data value is stored in said data store, to halt said second access request until completion of said first access request, and on detection of output of said first data value to retrieve said second data value from said data store and to transmit said retrieved value to said access circuitry for output; and said control circuitry being responsive to said third access request to access said data store and in response to a miss wherein a third data value is not stored in said data store to send a request to said retrieval circuitry to retrieve said third data value from said memory and to store said third data value in said data store and to halt said third access request and in response to said second access resuming to retrieve said third data value from said data store and to transmit said retrieved value to said access circuitry for output.

In some embodiments, said access circuitry is responsive to detection of completion of said first access request to issue a representation of said second access request.

As the second access request is halted to prevent it from outputting its value before the value accessed by the first access request is output, when the first access request has completed this access needs to be performed. This is done by issuing the request at this point, or a representation of the request. Thus, a command is sent so that the second access request is performed.

In some embodiments, said access circuitry is responsive to detection of issue of said representation of said second access request to issue a representation of said third access request.

Similarly, the third access request that has had output of its data inhibited, can be issued again or at least a representation of it can be issued once the second access request or a representation of it has been issued. In this case, it will now hit in the data store and thus, the data can be retrieved and output with only the latency of accessing the data store.

In some embodiments, said data storage circuitry is configured to assert said output inhibit signal in response to receipt of said subsequent ordered access request missing in said data store.

It may be advantageous to assert the output inhibit signal only after detecting that the subsequent ordered access has missed in the data store. If this access request hits, then the request is halted and there is no need to assert an output inhibit signal associated with it. Thus, in some embodiments the assertion of the output inhibit signal is done in response to the subsequent access request missing in the data store.

Although the data storage circuitry can take a number of forms, in some embodiments it comprises a level 2 cache.

A second aspect of the present invention provides a data processing apparatus comprising a processor core, data storage circuitry according to a first aspect of the present invention connected to the processor core by at least one bus and a memory for storing said data, said memory being connected to said data storage circuitry by at least one further bus.

A third aspect of the present invention provides a method of accessing data comprising: receiving a plurality of access requests from a processor, a first access request being to data not stored in said data store, a second being to data stored in said data store and a third being to data not stored in said data store, said method comprising the steps of: in response to said first access request, accessing a data store and in response to said requested data value not being stored in said data store accessing a memory to retrieve said data value; in response to said second access request, accessing said data store and in response to said requested data value being stored in said data store, halting said access; in response to said third access request accessing said data store and in response to said requested data value not being stored in said data store accessing said memory and retrieving said requested data value from said memory and storing said requested data value in said data store and halting said third access.

A fourth aspect of the present invention provides a storage and control means for storing data and controlling access to data stored in a memory, said means comprising: storage means for storing a subset of said data stored in said memory; access means for receiving access requests and for outputting said requested data, at least some of said received access requests being ordered access requests requiring said accessed data to be output in a same order as said access requests are received in; control means for controlling access to said data; and retrieval means for retrieving said data from said memory; wherein said control means is responsive to an access request received from said access means to access said storage and in response to detecting a miss in said storage means when said requested data is not stored in said storage means to transmit said access request to said retrieval means; said retrieval means being configured to retrieve requested data from said memory in response to said access request and to store said data in said storage means and being responsive to no asserted output inhibit signal associated with said data access request to transmit said retrieved data to said access means for output and being responsive to an asserted output inhibit signal associated with said data access request not to transmit said retrieved data to said access means; said storage and control means further comprising detection means for detecting an earlier ordered access request that misses in said data store and a later ordered access request that hits while said earlier ordered access request is pending, said data storage means being configured to halt said later ordered access request and in response to receipt of a subsequent ordered access request while said earlier ordered request is still pending to assert an output inhibit signal associated with said subsequent ordered access request and in response to detection of completion of said earlier ordered access request to deassert said output inhibit signal.

The above and other objects, features and advantages of this invention will be apparent from the following detailed description of illustrative embodiments which is to be read in connection with the accompanying drawings.

### BRIEF DESCRIPTION OF THE DRAWINGS

FIG. 1 shows a data processing apparatus according to an embodiment of the present invention;

FIG. 2 shows access circuitry according to an embodiment of the present invention;

FIG. 3 shows access circuitry according to an alternative embodiment of the present invention;

FIG. 4a shows a timing diagram for consecutive access requests that miss, hit and then miss in the L2 cache according to the prior art;

FIG. 4b shows a timing diagram for consecutive access requests that miss, hit and then miss in the L2 cache according to an embodiment of the present invention; and

FIG. 5 shows a flow diagram illustrating a method of controlling access to a data store according to an embodiment of the present invention.

### DESCRIPTION OF THE PREFERRED EMBODIMENTS

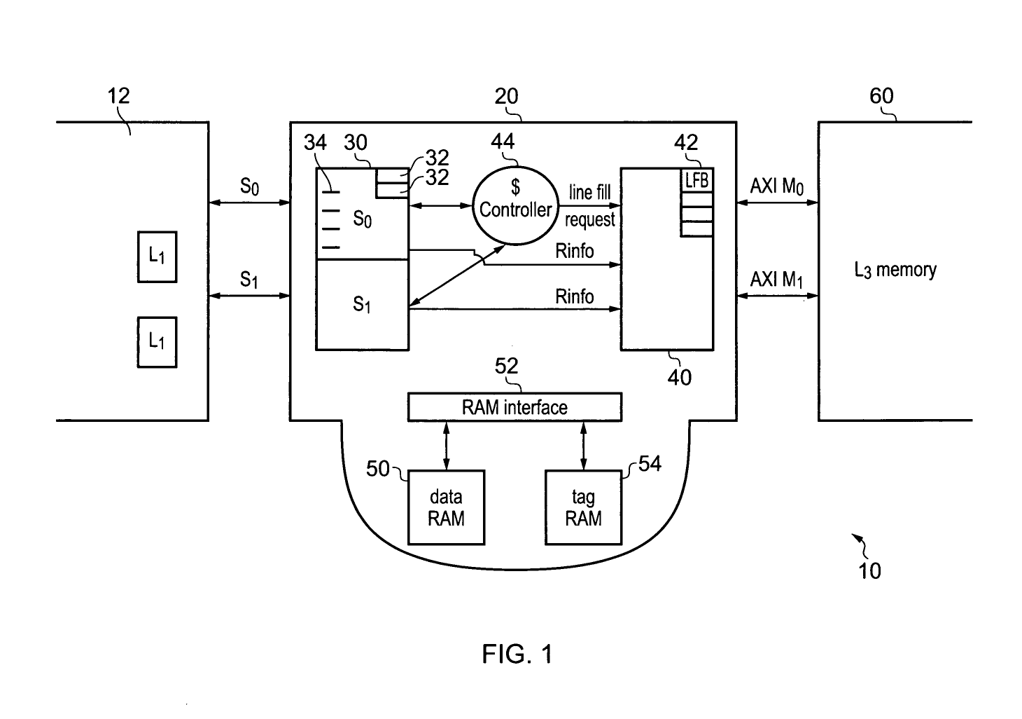

FIG. 1 shows a data processing apparatus 10, according to an embodiment of the present invention. Data processing apparatus 10 comprises a processing core 12 having one or more processors (not shown) and related L1 caches. It also comprises an L2 cache 20 and a memory 60. The processor core 12 sends access requests to read data that it requires that is not stored within its L1 caches via AXI buses S0 and S1 (AXI is a trademark of ARM Limited Cambridge England). These are received at the L2 cache by access or slave circuitry 30. In this embodiment there are two slave circuits that are identical and each is accessed by its own bus. The first slave S0 has two line read buffers LRB 32 for storing data that it has retrieved from the data RAM 50 prior to outputting it on the AXI bus. It also comprises four storage slots 34 that each store information relating to a received pending read request. Thus, four pending read requests can be processed in parallel with each other, information relating to these requests being stored in one of these storage slots.

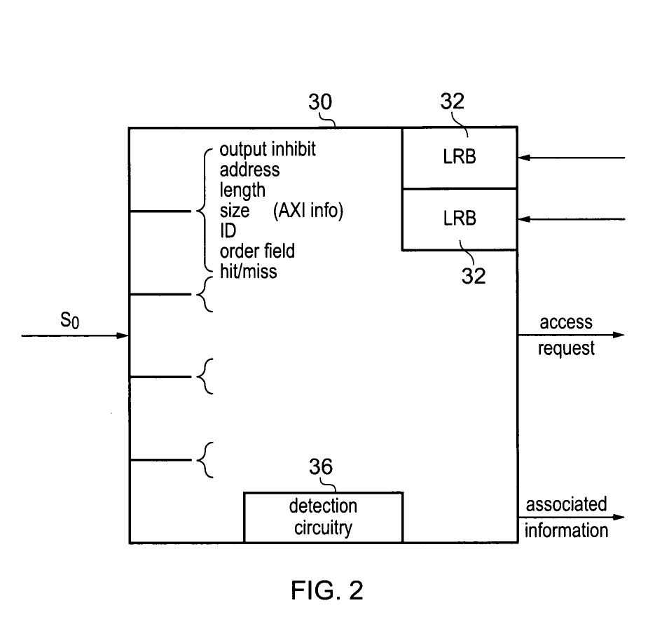

In addition to storing information received with the access requests these storage slots also store information relating to how the access is progressing. This will be described in more detail with respect to FIG. 2.

L2 cache 20 also comprises cache controller 44 that receives access requests from slave 30. Cache controller looks to see if the requested data is stored in the data RAM 50. It does this by querying RAM interface 52 and tag RAM 54 to identify whether or not the requested data value is stored in data RAM 50. If the requested data is stored in data RAM 50, then this is a hit and this information is sent back to the cache controller 44 which sends the information to the slave where it is stored in the respective slot. The data value is then retrieved from the data RAM 50 and stored in the line read buffer LRB 32 prior to being output.

If the data is not stored within data RAM 50 then this is a miss and a line fill request is sent to master 40. Master 40 will then request information associated with this line fill request from the slave and this information which is stored in the respective slot 34 is sent to the master. Master 40 then sends a data retrieval request via one of the AXI buses M0, M1 to the L3 memory 60. In response to this request the data is retrieved and stored in one of the four line fill buffers 42, and the data RAM 50 is updated with this retrieved value. The information that was associated with this access request is then checked to see whether or not there is an output inhibit signal asserted. If there is, then following the update of data RAM 50 the access request is stalled. If the output inhibit signal is not asserted, then the data value that has been retrieved and is in the line fill buffer is output via one of the AXI buses S0, S1 that connect L2 cache to the processor core 12. Thus, the data output when the data is retrieved from the memory does not require the line read buffer LRB 32, but can be output using the line fill buffer 42 of the master.

FIG. 2 shows a single slave circuit 30 in greater detail. It comprises two line read buffers LRB 32, which store data retrieved from the data RAM 50 prior to it being output. It also comprises four slots for storing information relating to four pending read requests. The information regarding the read requests is information that is sent with the request on the AXI bus S0 and information that relates to the processing of the request. The information sent with the request includes such things as the address of the requested data value, its size and an identification field which identifies where the request has come from. The identification field is used to determine if the pending access requests need to be processed in the order that they are received in. Access requests with the same ID need to be processed in their received order so that data output in response to these requests is output in the order that the requests were received in.

The information fields relating to the processing of the access requests include the output inhibit field, which is set to inhibit the output of a data value that is retrieved from the L3 memory 60. This value can be used in, for example, prefetch access requests, that are speculatively fetching values that may be required by the processor but are not needed yet. Fetching these in advance means that they will then be present in the data RAM 50 and the memory will not need to be accessed to retrieve them if they are required later. The value should not be output to the processor at this time as it is not required yet. Thus, assertion of this output inhibit signal allows an access request to fetch the value from the memory and yet inhibits it from outputting it to the processor. This output inhibit field is also used to maintain the order of certain data accesses and yet reduce their latency as will be described later.

There is also an order field which is used to record the order that access requests with the same ID are received in. This order field is updated as the access requests complete, and it is the access request with the lowest order field that is processed at any one time. There is also a hit/miss field which is updated by cache controller 44 and determines whether or not this access request has hit in the data RAM 50. This field can also be used to maintain order and to set the output inhibit field as will be described later.

Slave 30 also comprises detection circuitry 36. This detection circuitry is used to detect consecutive access requests that should execute in the order they are received in, i.e. they have the same ID, where a first of these access requests misses and a second hits in the data RAM 50. In response to detecting this occurring, detection circuitry 36 stalls the processing of the second access request so that the data that it retrieves is not output. This is done relatively quickly so that in addition to not being output this data is not retrieved from the data RAM and stored in the LRB 32. Detection circuitry 36 also responds to a next data access request to detect if it misses, if it does it asserts an output inhibit signal associated with this access request.

Thus, rather than not allowing this access request to be issued as occurred in the prior art, output of the data is inhibited. Thus, the access request is sent to master 40, the data is retrieved from the L3 memory 60 and data RAM 50 is updated with this value. Output of this data is inhibited and the access request halts following update of the RAM 50. When detection circuitry 36 detects that the first access request has completed and the requested data has been output, it resets the output inhibit field associated with the third access request.

Access circuitry 30 will resend the access request for the second access or a representation of it, in response to detecting that the first access request has completed. It will do this in response to the order field being updated. In response to the access request the data from the data RAM 50 will be retrieved as this was a hit and it will be output via LRB buffer 32. Following issuing of the second access request, the third access request will be sent to the cache controller 44. As data has been retrieved from the memory 60 for this access request, this too returns a hit and the data is retrieved from data RAM 50 and is sent via LRB buffer to be output. In this way, when there is a miss followed by a hit followed by a miss, there is only one latency for accessing the memory rather than two. This is because access of memory 60 for the third access request occurs at substantially the same time as access of memory 60 for the first access request and thus, as they do not happen consecutively the latency for these access requests is substantially reduced.

It should be noted that if there were as many line read buffers as there were slots, then in response to a hit for the second data access, the line read buffer could simply be filled with this data and it could await output, similarly, the third access request could be processed and the output could be controlled so that the data is output in order. However, line read buffers are expensive in area and thus, it is advantageous to have fewer line read buffers then there are slots. In order to alleviate the latency problems that arise with a miss followed by a hit and then followed by a miss, the output inhibit field which is present for handling prefetch instructions is used, and in response to the third data access request missing in the data store, this field is set and thus, the access to the L3 memory is performed immediately and the L2 cache updated, but as the output inhibit field is set no data is output.

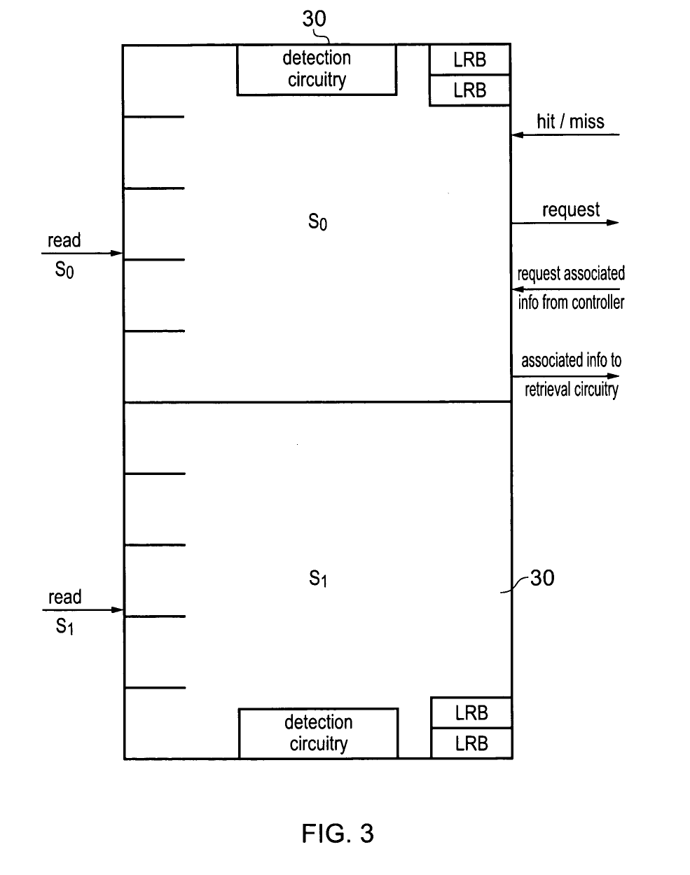

FIG. 3 shows slave 30 instantiated twice as in FIG. 1. In this embodiment the slave is a double slave each slave being a copy of the slave 30 of FIG. 2. In this case the slave receives read requests from two different AXI buses and has four storage slots for storing four pending read information and two line read buffers for storing data to the output in each of its two slaves. There is also detection circuitry associated with each slave for detecting the information stored in the slots for determining if there is an access request with the same ID where the first access request has missed and the second access request has hit, so that the second access request needs to be stalled before it fills its line read buffer and to detect if a third access request that misses is received whereupon the output inhibit field associated with this access request can be set.

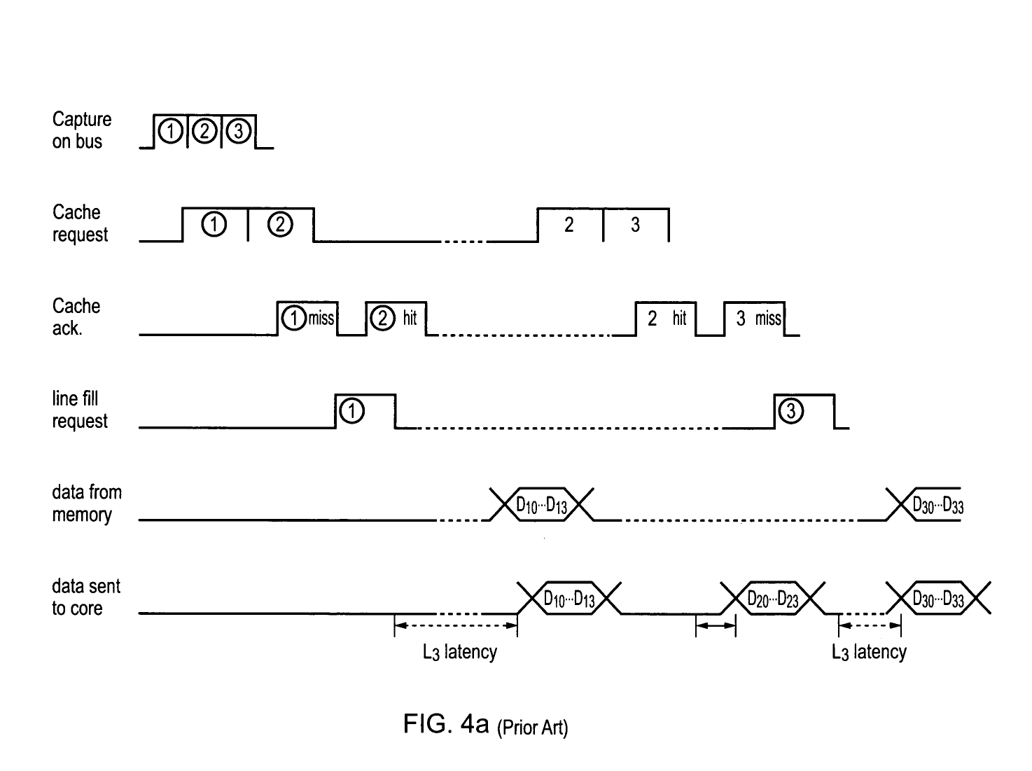

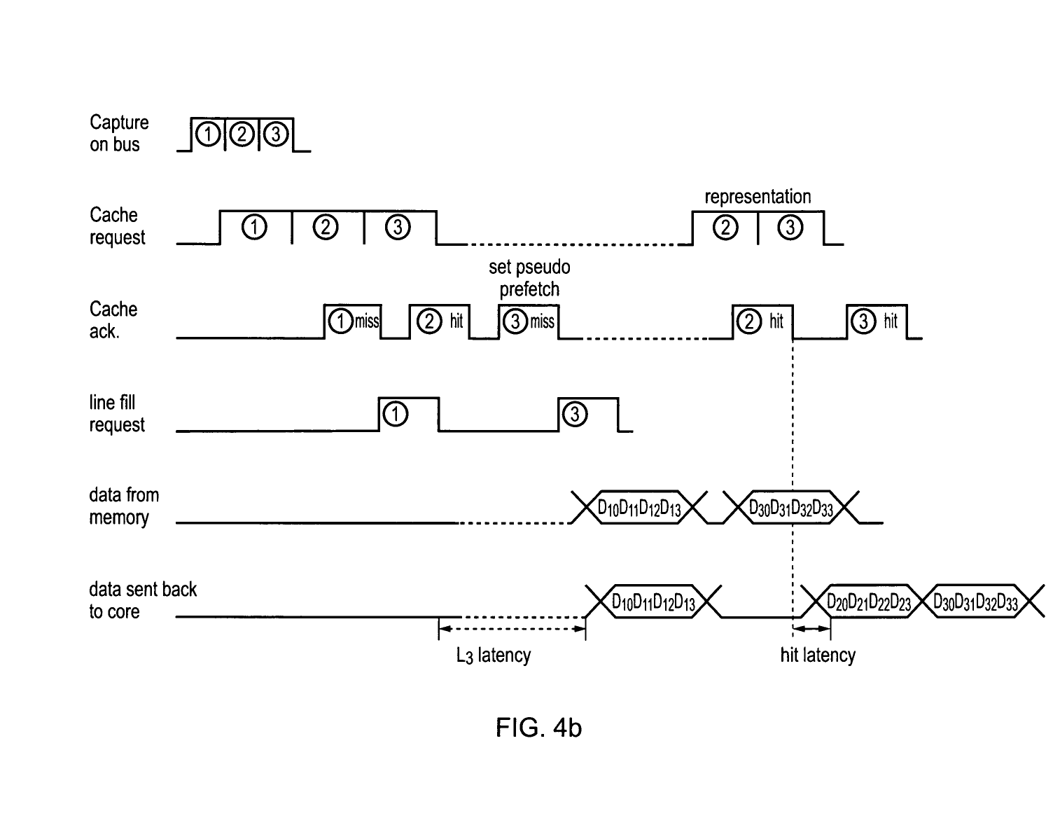

FIG. 4a shows a timing diagram of a system of the prior art, illustrating three consecutive accesses with a same ID a first request that misses, a second that hits and a third that hits.

Initially the three access requests are captured on the bus and are stored in the slots in the slave of the L2 cache. A cache request is then issued for the first and then the second requests, and in response to detecting a miss for the first request, the second request is halted and the third request is not issued. There is then a wait while the memory is accessed and the data from the first access request returned. When this access has been completed and the data has been sent to the core, a representation of the second access is issued as a cache request and the third request is then issued.

The second request hits in the cache and returns the data which is then output. However, the third request misses and thus, there is again a wait while the memory is accessed before a data value is returned to the core for the third access. Thus, in this case the latency for the three accesses includes two memory access latencies, which are generally of the order of 100 to 200 cycles, as opposed to a cache access latency of about 20 cycles.

FIG. 4b shows a timing diagram of the three access requests of FIG. 4a according to an embodiment of the present invention. In this embodiment, the three access requests are captured and are stored in the slots in the access circuitry. A cache request is then issued for each of the three requests. The first misses, the second hits and the third misses. A linefill request for the first access request and for the third access requests that have missed are issued and data for these requests is retrieved from the memory. The second request is halted in response to detecting it hit following the first one missing and in response to detecting the third request missing a “pseudo prefetch” or output inhibit signal is set. In response to this pseudo prefetch signal the third access request updates the L2 cache with the value retrieved from the memory but it does not output this value, rather the request is halted at this point.

When the first access request completes following data from the first access request being sent back to the core, a representation of the second access request that was halted is issued and this hits in the cache and returns the data. The third access request or representation of the third access request is issued after issue of the second access request and this now hits as the linefill request has returned the data to the cache and as the pseudo prefetch or output inhibit signal is no longer asserted the data can be sent to the core via an LRB. Thus, in this case the three access requests do not have the latency of two memory accesses.

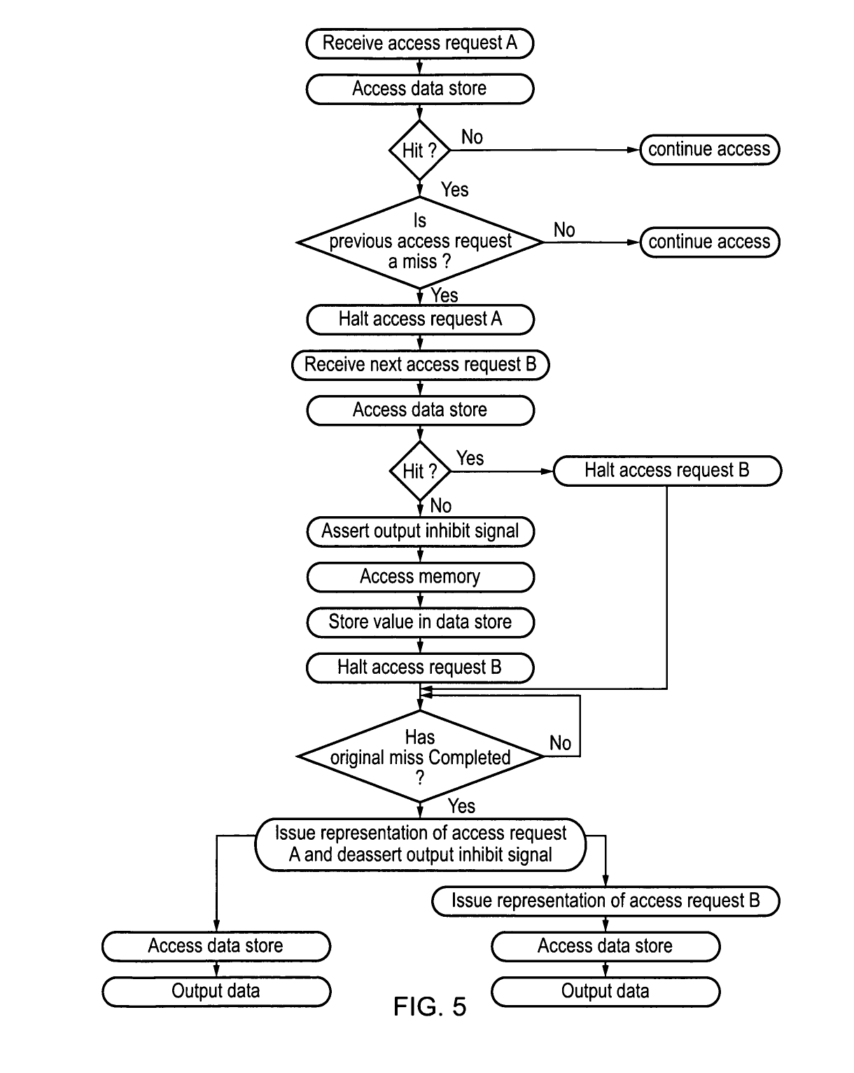

FIG. 5 shows a flow diagram illustrating a method of controlling data accesses according to an embodiment of the present invention. In response to receipt of an access request, which we will refer to as access A, the data store is accessed and it is determined if the request hits, i.e. the data requested is stored in the data store. If the access request misses, then the access continues in the normal fashion. If it hits, then whether or not the previous access request was a miss is determined. If it was not a miss then the access continues in the usual fashion. If the previous access request was a miss, then access request A is halted as it will return its data before the previous access and this should be avoided.

When the next access request, which we shall call access request B is received the data store is accessed and it is determined if it is a hit. If it is then this access request is halted to avoid it too outputting data before the two previous access requests. If it misses then an output inhibit signal is asserted. The memory is then accessed, the data value retrieved and stored in the data store and as the output inhibit signal is asserted the access request is then halted without the data being output.

The system then determines whether or not the original miss has completed. When it has completed a representation of the halted access request A is reissued and if the output inhibit signal is asserted then this is now deasserted. The data store is then accessed and data is output. Following issue of the representation of access request A, a representation of access request B is also issued and this now hits in the data store and data is retrieved and output.

Although illustrative embodiments of the invention have been described in detail herein with reference to the accompanying drawings, it is to be understood that the invention is not limited to those precise embodiments, and that various changes and modifications can be effected therein by one skilled in the art without departing from the scope and spirit of the invention as defined by the appended claims. For example, various combinations of the features of the following dependent claims could be made with the features of the independent claims without departing from the scope of the present invention.

We claim:

1. Data storage circuitry for controlling access to data stored in a memory, said data storage circuitry comprising:
a data store for storing a subset of said data stored in said memory;
access circuitry for receiving access requests and for outputting said requested data, at least some of said received access requests being ordered access requests requiring said accessed data to be output in a same order as said access requests are received in;
control circuitry for controlling access to said data; and
retrieval circuitry for retrieving said data from said memory; wherein
said control circuitry is responsive to an access request received from said access circuitry to access said data store and in response to detecting a miss in said data store when said requested data is not stored in said data store to transmit said access request to said retrieval circuitry;
said retrieval circuitry being configured to retrieve requested data from said memory in response to said access request and to store said data in said data store and being responsive to no asserted output inhibit signal associated with said data access request to transmit said retrieved data to said access circuitry for output and being responsive to an asserted output inhibit signal associated with said data access request not to transmit said retrieved data to said access circuitry;
said data storage circuitry further comprising detection circuitry for detecting an earlier ordered access request that misses in said data store and a later ordered access request that hits while said earlier ordered access request is pending, said data storage circuitry being configured to halt said later ordered access request and in response to receipt of a subsequent ordered access request while said earlier ordered access request is still pending to assert an output inhibit signal associated with said subsequent ordered access request and in response to detection of completion of said earlier ordered access request to deassert said output inhibit signal.

2. Data storage circuitry according to claim 1, wherein
said access circuitry comprises:
a plurality of storage slots each of said plurality of storage slots for storing information associated with one of said received plurality of access requests during processing of said access request;
at least one buffer for storing a data value retrieved from said data store prior to outputting said data value; wherein
said access circuitry comprises a greater number of storage slots than it comprises buffers; and
said data storage circuitry is configured to halt said later ordered access request before said later ordered access request stores a data value in said at least one buffer, and in response to detecting completion of said earlier ordered access request to issue said later ordered access request to said control circuitry again.

3. Data storage circuitry according to claim 2, said data storage circuitry being connected to a processor sending said access requests via a data bus wherein said buffers are a same size as a data value stored in said data store and said data bus has a smaller width than said data value size.

4. Data storage circuitry according to claim 1, wherein said access requests comprise identification data identifying a source of said access requests, access requests having the same identification data being said ordered access requests, said data storage circuitry being configured to output data from said ordered access requests in a same order that said ordered access requests are received in.

5. Data storage circuitry according to claim 1, said data storage circuitry comprising a data communication path between said access circuitry and said retrieval circuitry for transmitting information regarding an access request to said retrieval circuitry, said information including said output inhibit signal.

6. Data storage circuitry according to claim 2, wherein said information stored by said plurality of storage slots includes identification data identifying a source of said access requests and an order field, said storage slots having a same identification data having a value in said order field indicative of an order in which said slots received said requests, said access circuitry transmitting said access requests to said control circuitry in dependence upon said order field, said access circuitry being responsive to detection of completion of one of said access requests to update said order fields, and information regarding whether said access request hits or misses in said data store.

7. Data storage circuitry according to claim 2, said data storage circuitry further comprising a data communication path between said access circuitry and said retrieval circuitry for transmitting at least some of said information stored by said plurality of storage slots to said retrieval circuitry, said information further including said output inhibit signal.

8. Data storage circuitry according to claim 1, wherein
said retrieval circuitry comprises a line fill buffer for storing a data value retrieved from said memory prior to storing said data value in said data store.

9. Data storage circuitry according to claim 1, said access circuitry being configured to receive prefetch access requests, said prefetch access requests being speculative access requests that request a data value that it is predicted will be required by a subsequent access request, said data storage circuitry being responsive to receipt of one of said prefetch access request to assert said output inhibit signal associated with said one prefetch access request.

10. Data storage circuitry according to claim 1, wherein,
said access circuitry is responsive to three consecutive ordered access requests, a first of said three access request being to data not stored in said data store, a second being to data stored in said data store and a third being to data not stored in said data store to transmit said access requests in an order received to said control circuitry;
said control circuitry being responsive to said first access request to access said data store and in response to a miss wherein a requested first data value is not stored in said data store to send a request to said retrieval circuitry, said retrieval circuitry being responsive to said request to retrieve said first data value from said memory and to update said data store with said first data value and to complete said first access request by transmitting said retrieved first data value to said access circuitry for output; and
said control circuitry being responsive to said second access request to access said data store and in response to a hit wherein a second data value is stored in said data store, to halt said second access request until completion of said first access request, and on detection of output of said first data value to retrieve said second data value from said data store and to transmit said retrieved value to said access circuitry for output; and
said control circuitry being responsive to said third access request to access said data store and in response to a miss wherein a third data value is not stored in said data store to send a request to said retrieval circuitry to retrieve said third data value from said memory and to store said third data value in said data store and to halt said third access request and in response to said second access resuming to retrieve said third data value from said data store and to transmit said retrieved value to said access circuitry for output.

11. Data storage circuitry according to claim 10, said access circuitry being responsive to detection of completion of said first access request to issue a representation of said second access request.

12. Data storage circuitry according to claim 10, said access circuitry being responsive to detection of issue of said representation of said second access request to issue a representation of said third access request.

13. Data storage circuitry according to claim 1, said data storage circuitry being configured to assert said output inhibit signal in response to receipt of said subsequent ordered access request missing in said data store.

14. Data storage circuitry according to claim 1, wherein said data storage circuitry comprises a level 2 cache.

15. A data processing apparatus comprising a processor core, data storage circuitry according to claim 1 connected to said processor core via at least one bus and a memory for storing said data, said memory being connected to said data storage circuitry by at least one further bus.

16. A method of accessing data comprising:
receiving a plurality of access requests from a processor at a data store, a first access request being to data not stored in said data store, a second being to data stored in said data store and a third being to data not stored in said data store, said method comprising the steps of:
in response to said first access request, accessing said data store and in response to said requested data value not being stored in said data store accessing a memory to retrieve said data value;
in response to said second access request, accessing said data store and in response to said requested data value being stored in said data store, halting said access;
in response to said third access request accessing said data store and in response to said requested data value not being stored in said data store accessing said memory and retrieving said requested data value from said memory and storing said requested data value in said data store and halting said third access.

17. A method according to claim 16, comprising the further steps of:
in response to completion of said first access request issuing said second access request and retrieving said data value from said data store and outputting said data value; and
in response to issuing of said second access request in response to said first access request completing, issuing said third access request and retrieving said data value from said data store and outputting said data value.

18. A method according to claim 16, comprising a further step of in response to said requested value of said third access request not being in said data store asserting an output inhibit signal associated with said third access request and in response to said first access request completing deasserting said output inhibit signal, an asserted output inhibit signal inhibiting output of data from a request associated with said signal.

19. A storage and control means for storing data and controlling access to data stored in a memory, said means comprising:
storage means for storing a subset of said data stored in said memory;
access means for receiving access requests and for outputting said requested data, at least some of said received access requests being ordered access requests requiring said accessed data to be output in a same order as said access requests are received in;
control means for controlling access to said data; and
retrieval means for retrieving said data from said memory; wherein
said control means is responsive to an access request received from said access means to access said storage and in response to detecting a miss in said storage means when said requested data is not stored in said storage means to transmit said access request to said retrieval means;
said retrieval means being configured to retrieve requested data from said memory in response to said access request and to store said data in said storage means and being responsive to no asserted output inhibit signal associated with said data access request to transmit said retrieved data to said access means for output and being responsive to an asserted output inhibit signal associated with said data access request not to transmit said retrieved data to said access means;
said storage and control means further comprising detection means for detecting an earlier ordered access request that misses in said data store and a later ordered access request that hits while said earlier ordered access request is pending, said data storage means being configured to halt said later ordered access request and in response to receipt of a subsequent ordered access request while said earlier ordered request is still pending to assert an output inhibit signal associated with said subsequent ordered access request and in response to detection of completion of said earlier ordered access request to deassert said output inhibit signal.
